(19) United States
(12) Patent Application Publication
(10) Pub. No.: US 2008/0104885 A1
(43) Pub. Date: May 8, 2008

(54) STATIC REACTOR SYSTEM

(76) Inventor: Jacques Sinoncelli, San Anselmo, CA (US)

Correspondence Address: WINSTON & STRAWN LLP;PATENT DEPARTMENT, 1700 K STREET, N.W., WASHINGTON, DC, 20006, US

(21) Appl. No.: 11/854,883

(22) Filed: Sep. 13, 2007

Related U.S. Application Data
(60) Provisional application No. 60/844,456, filed on Sep. 14, 2006.

(51) Int. Cl. B01F 15/02; C10L 1/18

(52) U.S. Cl. 44/451; 366/133

(57) ABSTRACT

A chamber is formed by the gap between two similarly shaped shells or manifolds, such as spheres or cylinders, one slightly smaller and placed inside the other. The input materials are mixed thoroughly as they flow under high shear through the narrow gap at a flow rate determined by the system configuration. The gap region is made narrow to prevent the formation of vortices that tend to entrain input materials in isolated regions and thus prevent their thorough mixing with each other. This mixing method uses pressure to create high-shear flow mixing rather than using mechanical motion and the direct action of moving parts to create the shear required for mixing.

### CROSS-REFERENCE TO RELATED APPLICATIONS

This application claims the benefit of provisional patent application No. 60/844,456, filed Sep. 14, 2006, entitled “Static Reactor System” by Michael B. Brown and Jacques Sinoncelli, which is hereby incorporated by reference in its entirety. This application is also related to disclosure document number 602,445, filed Jun. 17, 2006, entitled “Static Chemical Reactor System” by Michael B. Brown and Jacques Sinoncelli, which is also hereby incorporated by reference in its entirety.

### FIELD OF THE INVENTION

This invention is generally concerned with materials processing by mixing, such as in chemical reactions, where input materials are combined or mixed to create an output result, and more specifically with mixing or blending as it pertains to chemical reactions such as oxidation, reduction, condensation, esterification, ozonation, halogenation, nitration, cyanation, hydrolysis, dehydroxation, epoxidation, diazotization, olefination, alkylation, acylation, boration, and formylation, among others.

### BACKGROUND OF THE INVENTION

Apparatus for materials processing, particularly related to promoting chemical reactions, are known. There are various forms of active mixers using paddles or beaters within a tank. There are also various static mixers that use a number of internal vanes or fins to mix fluids that flow through them, such as the Sulzer SMV mixer.

Some recent mixing approaches use nanotechnology, which makes them more suitable for small scale applications such as laboratories or diagnostics. The Goran Jovanovic method developed at OSU uses narrow micro-channel mixing which has very low output. Also the Abraham Stroock method, developed at Harvard, uses a wider micro-channel but with ridges to promote folding. There is also the similar Chou et al., U.S. Pat. No. 6,551,836 which uses micro-channels. These nanotechnology-based methods do not use high-shear boundary layer mixing.

High-shear boundary layer mixing for combining reagents is used by Holl, U.S. Pat. No. 6,752,529, but with direct mechanical force and the direct action of moving parts to create the shear required for mixing. Specifically, the Holl approach uses a Couette-like pair of cylinders with a common axis and a rotating inner cylinder which facilitates mixing. There is also the earlier Holl U.S. Pat. No. 5,279,463 showing alternate configurations, including two rotating disks configured similar to mill stones.

Couette used this two cylinder configuration with a wide gap to measure the viscosity of fluids. The viscosity was related to the torque required to rotate the inner cylinder. G. I. Taylor investigated the behavior of fluid in this same cylinder configuration systematically, as the two cylinders rotated in different directions and speeds. Taylor found that once the inner cylinder reached a certain speed, the centrifugal force caused the laminar flow to transition into a column of toroidal vortices concentric with the cylinder axis. The planar cross-section through the cylinder axis shows alternating flow directions of clockwise and anti-clockwise, providing cooperating flows between adjacent vortices from the inner cylinder to the outer cylinder and back again. Such toroidal vortices entrain most of the available fluid into separate flow systems which react only weakly with each other.

Görtler studied the flow of fluid along concave surfaces. Such flow also creates centrifugal forces that can result in vortices. Such Görtler vortices are much less regular than the Taylor vortices and seem to require upstream irregularities for their formation. Gortler vortices can also entrain materials and so reduce mixing efficiency.

### SUMMARY OF THE INVENTION

The Static Reactor System mixes materials using a pressure-driven high-shear approach which is suitable for high throughput production.

One aspect of the present invention relates to materials processing and chemical reactions. In certain embodiments a shear flow within a processing chamber is achieved primarily by pressure rather than moving parts. The chamber is configured to minimize vortices that entrain materials and thus reduce mixing efficiency. It is to be understood that embodiments of the invention can be used, in whole or in part, for the physical mixing of components resulting in, for example, emulsification without necessarily involving a chemical reaction.

In one embodiment relating to a static reactor system the processing chambers have no moving components themselves, thereby simplifying the construction and lowering maintenance costs and wear.

The internal pressure within each processing chamber is determined by the differential input and output pressure. Flow through a unit is determined by the input pressure as well as the internal resistance to flow and the output flow constraints. In addition, the temperature within a processing chamber can be controlled by both the materials input temperature as well as by heat or other energy supplied through either or both of the outer surface of the processing chamber or through the inner surface of the unit. Such pressure, temperature and flow can be controlled by subsystems that manage valves, pumps and heating or energy production subunits throughout the system. Note that other energy applied can include radio frequency, RF, energy, including Microwave energy.

### BRIEF DESCRIPTION OF THE DRAWINGS

The figures described below show particular preferred embodiments of the invention. They are not intended to limit the forms of the invention or the possible additional components that may be used with the invention.

FIG. 1 shows a basic reactor system using a cylindrically shaped processing chamber.

FIG. 2 shows a basic reactor system using a spherically shaped processing chamber.

FIG. 3 shows in more detail some of the components and their relationships that can be found in a complete processing system.

FIG. 4 shows how the Control Unit manages temperature, pressure and flow rate through the Processing Unit.

### DETAILED DESCRIPTION OF THE PRESENT INVENTION

Mixing is a process by which fluid particles that were initially a large distance apart are brought close together. Initially two fluid regions are separated by a two dimensional boundary surface. If this fluid is to be mixed, such that the typical distance between different regions has been considerably reduced, the boundary between the different fluids must be distorted so that its area is greatly increased. Rapid mixing can therefore be achieved by the efficient stretching and folding of material lines and surfaces.

It has been found that some forms of mixing produce vortices that impede mixing at the smaller scales toward the molecular range. By constraining the mixing process to a narrow region whose gap is less that the size of the Taylor Vortices, such vortices can be prevented from forming.

Further, whenever fluid flows over a concave surface, centrifugal forces can cause Gortler Vortices. However, since these vortices seem to be caused by upstream irregularities, they can be largely prevented by reducing such surface irregularities, by using surface preparation techniques such as plating, polishing, deposition, glass lining, or the production of units from molds without irregularities themselves. However prepared, the surfaces of the mixing chamber or passage therefore preferably have surface irregularities of ten microinches or less.

Once vortices are eliminated or reduced, high shear flow results in highly efficient mixing close to the molecular level, significantly enhancing the speed of chemical reactions.

According to Kolmogorov's Universal Equilibrium Theory, large-scale turbulent motion is roughly independent of viscosity. The small-scale, however, is controlled by viscosity. Fluctuation energy is produced at the large eddies with larger wavelengths. Stretching of eddies then generates smaller and smaller eddies while energy flows down the spectrum to the smallest wavelength region. The energy is mainly dissipated into heat at the smallest eddies in the Kolmogorov scales. Generally the eddy sizes follow the decreasing sequence: largest, energy-containing, most-dissipative, Kolmogorov-scale.

At the molecular level, the dissipation of turbulence is caused by molecules carrying their momentum from one eddy to the next. In a qualitative sense, it is apparent that they will also carry their molecular constituents to the adjacent eddy and thus turbulent dissipation results in mixing at the molecular level.

Chemical reactions depend on mixing at the molecular level rather than on the average, over large-scale regions, hence the turbulent dissipation region coincides with the region at which molecular mixing and reaction take place. Mixing occurs in a processing chamber that comprises adjacent surfaces separated by a distance small enough to prevent Taylor vortices. The surfaces inside the chamber have been created or processed to avoid irregularities that might cause other vortices, such as Görtler vortices. The geometry of the chamber and configuration of the surfaces may vary in different embodiments and may be tailored to and optimized for specific reactions and mixing demands. Exemplary implementations include concentric spheres, concentric cylinders, flat plates separated by a gap with sealed sides, and various other shapes and topological transformations of the aforementioned configurations.

The input pressure to the unit is sufficient to create high shear flow within the passage or gap of the processing chamber to facilitate fast and complete mixing of reagents. This required input pressure will of course vary depending up on the materials to be mixed, the conditions under which the mixing is undertaken, such as the temperature and other ambient conditions, and the particular implementation of the chamber. Typically, high pressure on the order of several atmospheres will be needed to create the high shear flow. The pressure, heat or energy input, gap size, surface configuration or preparation within the gap region are controlled in order to minimize or eliminate the formation of vortices. Pre-mixing before passage through the main processing chamber may also be employed in certain embodiments. The length of the mixing path from inlet to outlet may also be varied, and the reagent mixture may also be recycled through the mixing chamber multiple times. The mixing path may also be coated with catalytic materials. Multiple pathways within a given gap may also be employed. Further, entire systems may be ganged in series.

A control unit simultaneously manages the temperature, pressure, and flow rate inside the processing chamber where the mixing or reaction occurs. To accomplish such management the control unit uses various sensors, internal computations and output to actuators, such as pumps, throttle valves, heaters and coolers.

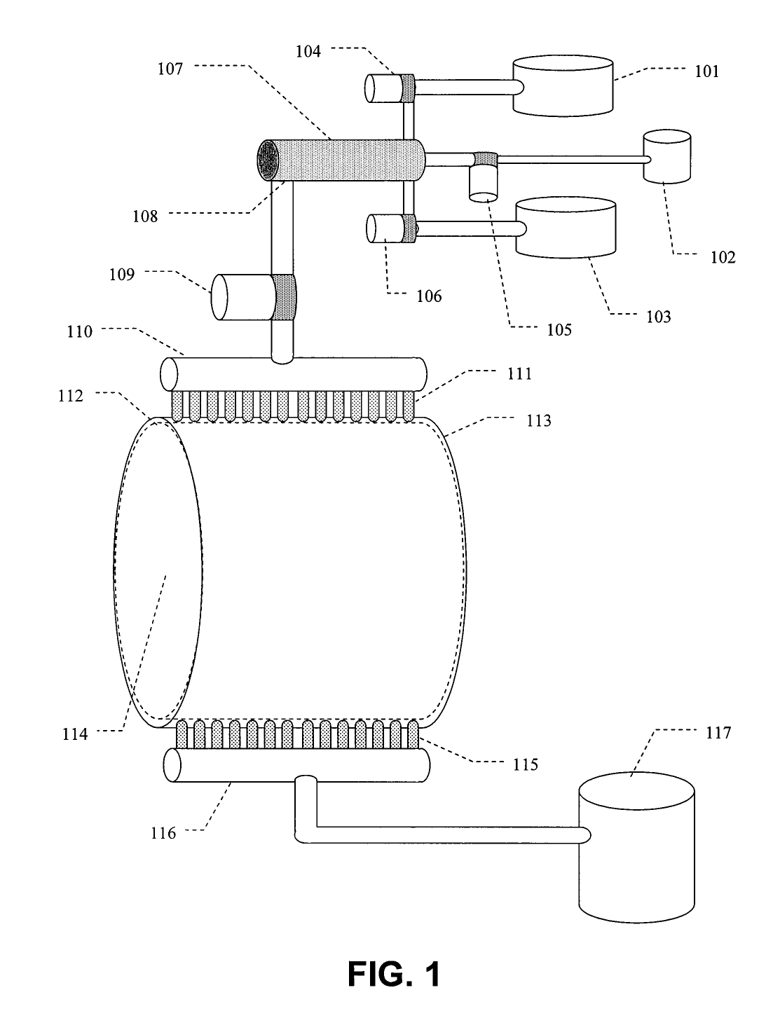

FIG. 1 illustrates a processing unit for the Static Reactor System, with a processing chamber comprising two concentric cylinders.

Element 113 is the outer cylinder while 112 is the inner. Since 112 is slightly smaller, this creates a narrow annular gap between the two cylinders where reagents or components flow. This gap is a passage of the processing chamber formed by the inner and outer cylinders. The flat ends of cylinders 113 and 112 are sealed to contain the reagents or components introduced.

In this preferred embodiment of the invention there are two reagents that are combined with a catalyst. The static reactor system shown in FIG. 1 can be used for processing any number of materials but is particularly useful for processing biodiesel fuel.

Element 101 is a supply for reagent 1; element 103 is the supply for reagent 2; and 102 is the catalyst supply. In the event that the system is used to process biodiesel fuel, the reagents and material to be mixed may include alchohol and some type of oil or grease, and the catalyst may include a hydroxide such as sodium or potassium hydroxide. Metering pumps 104, 105, and 106 supply the respective input components, comprising reagent 1, reagent 2 and the catalyst, to the mixing subunit 107 in the correct proportions determined by the type of reaction to be accomplished or by the type of mixing to be performed. Element 107 is a continuous flow mixing unit that performs a preliminary mixing step. In the preferred embodiment element 107 is a static mixing unit in order to lower energy usage and reduce the complication of unnecessary moving parts.

The pre-mixed components exit the mixing unit 107 at the outlet 108 and flow to a high-pressure pump 109. The pressure created by pump 109 creates the appropriate velocity of flow through the main processing chamber between cylinders 112 and 113.

The pre-mixed components enter the processing chamber under pressure through a series of inlets 111 which are supplied from a distribution manifold 110 connected to the high pressure pump 109. As mentioned earlier, pressure needed to achieve high shear flow varies depending on the application and implementation but is on the order of several atmospheres. In the case of biodiesel processing, the pressure should be controlled at the input manifold 110 to be about 100 p.s.i. or greater.

Mixing and or reaction take place as the pre-mixed components flow through the processing chamber toward the outlets 115 through which the combined reagents exit into the collection manifold 116. The processed components or reagents are then collected into a tank 117. Depending on a number of factors, the output from the processing chamber may be subject to further processing such as centrifugal separation or various forms of purification. In the example of biodiesel processing, tank 117 will contain biodiesel fuel and glycerin. It will also contain the catalyst or a derivative thereof. In such a case, the additional separation and purification serve to separate the biodiesel fuel from the glycerin and catalyst/derivative.

For each processing application the distance between the surfaces of the processing chamber (i.e. the size of the gap) necessary to prevent the formation of vortices will vary. For example the distance will vary based on operating conditions such as the type, temperature, pressure, and viscosity of the materials being mixed. For the example of biodiesel fuel, the gap is preferably between 0.25 and 0.50 mm.

Note that that FIG. 1 is but one example of a processing chamber and is not meant to limit the shape or configuration of such a chamber.

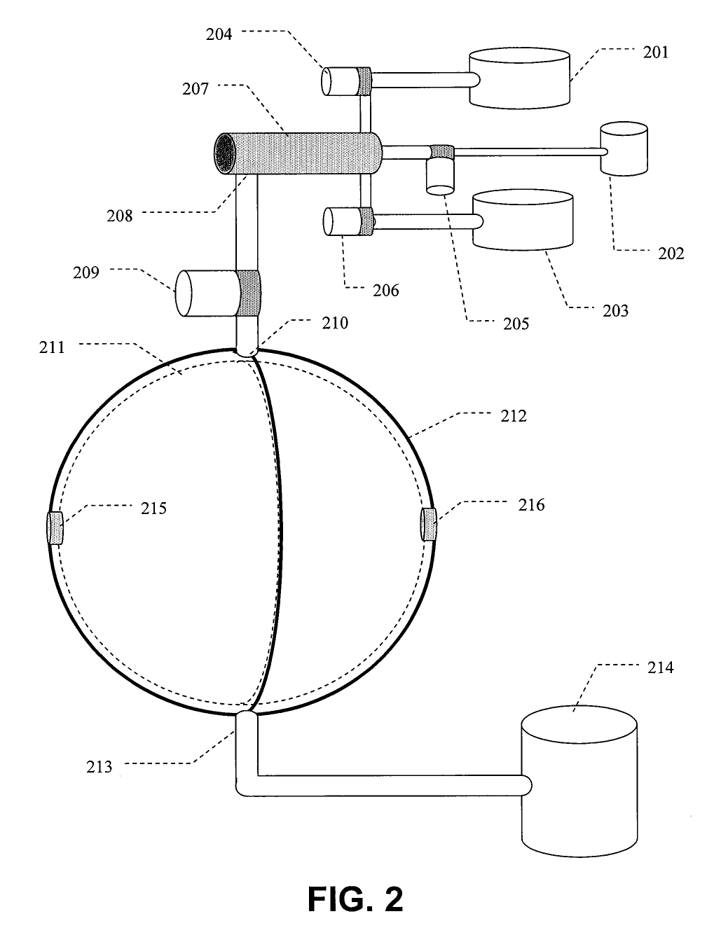

An alternate form of the invention is seen in FIG. 2, where the processing chamber is made of two concentric spherical components. There exists a gap between the outer diameter of the inner sphere 211 and the inner diameter of the outer sphere 212. The input and processing of components is similar to that in FIG. 1.

The two input material components are fed from tanks or supplies 201 for reagent 1 and 203 for reagent 2. A catalyst is fed from a tank or supply 202.

Elements 204, 205, and 206 are the metering pumps to supply the input components, consisting of reagent 1, reagent 2 and the catalyst, to the mixing subunit 207 in the correct proportions determined by the type of reaction to be accomplished or by the type of mixing to be performed. Element 207 is a continuous flow mixing unit that performs a preliminary mixing step.

The pre-mixed components exit the mixing unit 207 at the outlet 208 and flow to a high-pressure pump 209. The pressure created by pump 209 creates the appropriate velocity of flow through the main processing chamber between the spherical components 211 and 212. The pre-mixed components, now under pressure, enter the processing chamber at inlet 210.

Mixing and reaction take place as the pre-mixed components flow through the processing chamber toward the outlet 213. The processed or reacted output product is then collected in a collection tank 214.

In this form of the invention the two spherical components are attached by means of fixed mechanical connections 215 and 216. Such connections may also be used to secure the complete two-sphere assembly. The connections 215 and 216 may also be used to provide access to the inside of the inner sphere 211, for instance to supply heat to the inner sphere, either directly or through some form of heat exchanger. Such heat would raise the temperature of the processing chamber, thereby heating the input components to be mixed or reacted as they flow through the processing chamber. Such heating will typically increase the speed of chemical reactions.

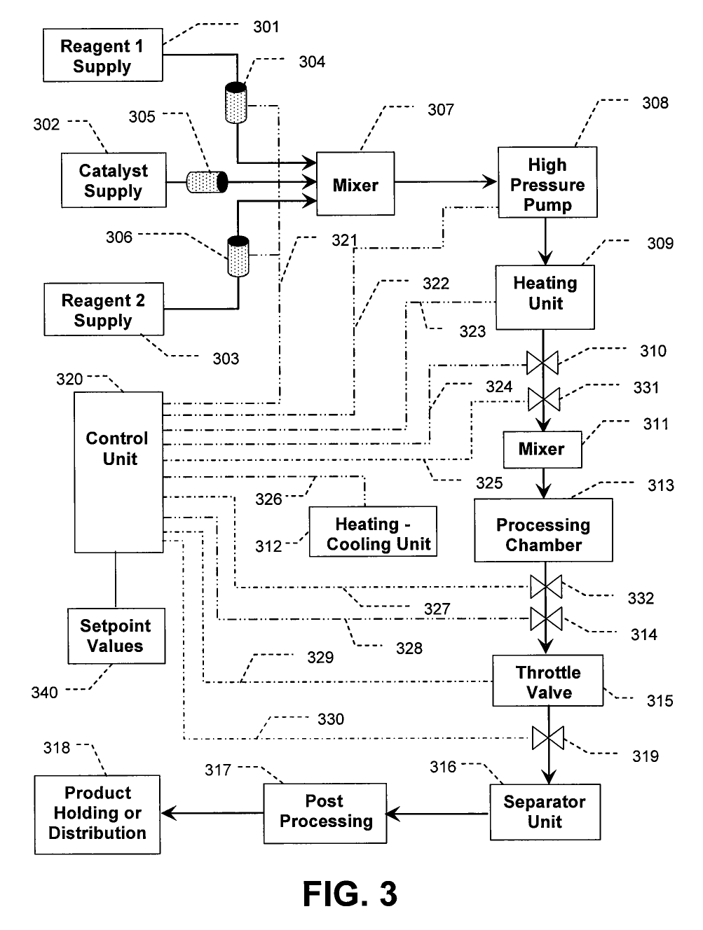

FIG. 3 provides a more complete view of the overall system, including the Control Unit 320 which coordinates the operation of the various operational components within the system.

Two factors in chemical reactions are temperature and pressure. Typically increased temperature leads to faster reactions, while increased pressure is often needed to keep more volatile constituents in a liquid state. Consequently in the processing chamber 313 it is desirable to supply heating both for the unit itself, via a heating unit 312, as well as for the input constituents, via heating unit 309, while also maintaining pressure within the processing chamber. It is desirable to optimize the use of the energy required for such heating. In the case of processing biodiesel fuel, increased temperature is desirable because it may increase the processing speed of the fuel, but has the negative consequence of causing the alcohol to boil or evaporate into a gaseous state, which requires containment. The cost of the energy required for heating must also be balanced with the increased yield.

Further, the system manages the pressure differential between the input and the output of the processing chamber in order to ensure the proper rate of flow through the chamber. The pressure sensing unit 310 measures the input pressure and unit 314 measures the output pressure. The control unit manages the output pressure by means of the throttle valve 315. The control unit manages the input pressure of the processing chamber by changing the output setting of the high-pressure pump 309.

The pressure differential between the input and the output of the processing chamber is one parameter determining the flow rate through the chamber. The viscosity of the fluid and the configuration of the chamber are other parameters determining flow rate. The control unit can determine the differential pressure by reading the input pressure sensor 310 and the output pressure sensor 314. The pressure values are communicated to the control unit 320 via the respective communication connections 324 and 328.

The overall pressure profile within the processing chamber is determined in part by the pressure created by the high pressure pump 308 combined with the setting of the throttle valve 315. Raising the output pressure by using the throttle valve will raise the pressure profile within the processing chamber. Raising the input and output pressures the same amount will keep the same basic flow rate while increasing the overall pressure within the processing chamber.

For a given set of reagents or input constituents, a particular temperature and pressure, as well as the flow rate for the reaction or processing will be selected and set into the control unit. The control unit will then insure that the selected temperature, pressure and flow rate in the processing chamber will be maintained.

FIG. 3 shows one particular instance of the invention with two reagents and one catalyst. However, the invention is intended to work with any combination of reagents or input constituents, as well as different catalysts or combinations thereof. In the general case it is intended that some or all of the input constituents may not be chemically active or reactive in which case at least part of the function of the invention will be the physical mixing of certain combinations of materials.

For FIG. 3 there are two reagent supplies, 301 and 303, as well as one catalyst supply 302. The supply can be a tank or other source. The purpose of the metering pumps 304, 305, and 306 is to supply the input constituents in the correct proportion for subsequent reaction or mixing in the processing chamber and with the right pressure for input to the preliminary mixer 307. These proportions and pressures are managed by the control unit 320. The control unit specifies settings for the respective metering pumps via the communication connection 321.

In general, a communication connection may be constructed in various ways, including but not limited to a multi-wire cable where separate wires connect to separate units or also including a cable carrying combinations of digital signals for a specified communication protocol, allowing control values to be written to or read from the various units that may be connected to the said cable. For a sensor unit one may say either that the sensor sends its value back to the control unit or that the control unit reads the setting from the sensor unit. Although the descriptions differ, they both represent the same basic underlying function. Similarly, for a controlled functional unit, such as a pump or heater, one may say either that the functional unit receives the setting from the control unit or that the control unit writes the setting to the functional unit, with the same basic meaning.

The output from the preliminary mixer goes to the high pressure pump 308 and then to the input heater 309 in preparation for going to the processing chamber. The high pressure pump 308 receives its pressure setting from the control unit 320 via the communication connection 322. The heating unit 309 receives its setting from the control unit 320 via the communication connection 323.

At this point the pressure sensing unit 310 measures the pressure and sends the pressure value back to the Control Unit 320 via the communication connection 324. After that the temperature sensing unit 331 measures the temperature and sends the temperature value back to the Control Unit 320 via the communication connection 325.

Just before the processing chamber there is an optional mixing stage 311. This may consist of one or more mixing nozzles that feed directly into the processing chamber 313, in which case they would, in most instances, be mounted directly on the processing chamber. For instance, such nozzles could be integrated with the inlets labeled 111 in FIG. 1 so that their spray impinged directly on the inner cylinder 112.

Next the pre-mixed and heated input constituents enter the processing chamber 313 under pressure where pressure, temperature and flow rate are controlled by the control unit 320. Additional heat can be supplied by a heating-cooling unit 312 connected directly to the processing chamber. Endothermic reactions that absorb heat may require additional heating from heating unit 312. Exothermic reactions that generate heat may require the removal of excess heat, in which case heating unit 312 can be used for cooling. For systems that are restricted to limited uses, 312 can be replaced by either a heating-only or a cooling-only unit, as appropriate.

The input constituents flow through the processing chamber with a high-velocity, high-shear flow. The chamber is configured to suppress or avoid the formation of vortices, as described above, in part through the use of a large surface area but low volume mixing region within a narrow gap having smooth interior surfaces. High shear flow without vortices produces mixing and reaction that is fast and efficient. The output from the processing chamber passes the temperature sensor 332 and the pressure sensor 314 which each send their values to the control unit via the respective communication connections 327 and 328. The processing chamber output then goes through the throttle valve 315 which receives its setting from the control unit 320 via the communications connection 329. The setting of the throttle valve determines the pressure within the processing chamber. Next the flow goes through the flow meter 319, which measures the rate of flow.

This system requires a precise flow rate for consistent mixing through the processing unit. The flow meter 319 measures the flow rate and communicates the value back to the control unit via the communication connection 330. The control unit then manages the high pressure pump 308 and the throttle valve 315 to control the flow through the processing chamber as well as the pressure within the chamber.

Following 319 the processed output goes to an optional separator unit 316. Some chemical reactions produce multiple result chemicals. Biodiesel production, for instance, produces an ester and glycerin, the latter of which needs to be separated out. Such separation may employ a number of means, including the use of one more centrifuges.

After the optional separation stage, further post-processing may be required at 317 such as the removal of catalysts or various types of purification. Note that post-processing and separation stages can come in different combinations and orders in different situations.

Finally, the output is either held in tanks, used immediately or distributed by other means at 318.

Again note that while FIG. 3 is a preferred embodiment, it should not limit the claims of the present application.

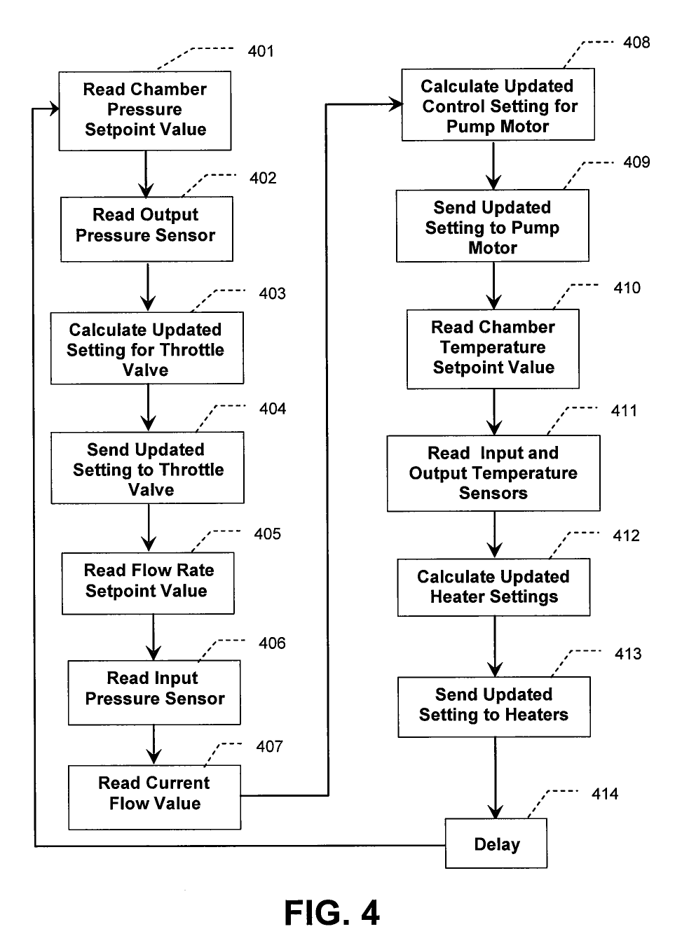

Please refer to FIG. 4 which describes the operation of the Control Unit 320.

The Control Unit has access to setpoint values for temperature, pressure, and flow rate. These values are usually specified from external sources and are stored as indicated by 340 in such a way that they are accessible to the Control Unit. The setpoint values can be specified in many ways, including, but not limited to rotary dial settings on a control panel or input shown on a computer display screen via keyboard or mouse.

The operation of the Control Unit uses aspects of control systems, a well-studied field. Feedback in such systems can be either analog or digital. In the simplest case the current sensor reading of a certain aspect is subtracted from the desired setpoint and the difference is used to compute the amount and direction of change for a control setting that modifies that aspect. Some such systems also include a difference history as well as trend or derivative in the calculations to help control undesired feedback effects such as overshoots. Note that the control unit can provide for various forms of manual settings and control.

This particular system uses a unique combination of features to control both flow and pressure by managing pressure pumps and throttle valves with a feedback control mechanism. For a particular processing chamber, the flow rate through the chamber is a function of the pressure differential between the input and the output of the chamber. In most chamber configurations, the minimum working pressure within the chamber will be at the outlet. Consequently the system uses the outlet pressure to measure the chamber working pressure at pressure sensor 314 which is then managed by a throttling valve 315 at the chamber outlet.

The preferred embodiment uses a computer looping approach to periodically update actuator settings for the pump speed, the throttle valve and the heater-cooler. The update cycle begins at 401 where the desired pressure setpoint is read. At 402 the system then reads the current pressure sensor value located at 314. Then the updated setting for the throttle valve is calculated at 403. Such calculation typically involves the difference between the setpoint and the sensor readings, but may include storing historical sensor values and using calculations based on such historical data to compute values for recent history averages and trends. Such calculations are well-known by those versed in the art. At 404 the updated setting is sent to the throttle valve which increases or decreases the constriction on the flow at 315 which then changes the pressure upstream of 315. The calculation for the throttle valve setting can also include recent changes to the pump motor speed, since increased pump speed will lead to increased pressure at pressure sensor 314 without any changes to the throttle valve setting.

At 405 the Control Unit reads the flow rate setpoint. At 406 the Control Unit reads the current pressure values from the sensors at 310 and 314 and then at 407 the flow value from the sensor at 319. Then at 408 the input pressure, flow rate and the setpoint value for the chamber pressure are used to calculate a new setting for the pump motor 308 which is sent via the communication connection 322 at 409.

The flow rate setpoint value is used to derive the pressure differential desired between 310 and 314. This derived value is cross-checked by examining the actual flow rate. If more or less flow is desired, the pressure differential is adjusted appropriately. Adding the differential to the output pressure value read at 314 determines the target pressure at the input 310. This derived target pressure is, in effect, a derived pressure setpoint for the value at 310. Given this derived setpoint and the actual value at 310, the system derives a new value for the pump speed that aims at minimizing this difference, using standard control system feedback techniques.

At 410 the Control Unit reads the temperature setpoint. At 411 the Control Unit reads the current temperature values from the sensors at 331 and 332. The input temperature differential from the setpoint and that measured at 331 is used to manage the heater settings for the heater 309, sent to the unit via communication connection 323.

The output temperature differential from the temperature setpoint and that measured at 332 is used to manage the heater settings for the heating-cooling unit 312, sent to the unit via communication connection 326. If the actual temperature is above the setpoint, cooling can be used, otherwise heating can be used if desired. The unit 312 is optional, but may be of value in certain types of processing.

At 411 the input and output temperature sensors are read. At 412 the updated settings are calculated and then at 413 are sent to the appropriate units, 309 and 312.

Finally, at 414 a delay is introduced in order to allow the new settings to take effect and be registered on the various sensors. After the delay, the cycle repeats, starting at 401.

Although the various aspects of the present invention have been described with respect to certain embodiments, it is understood that the invention is entitled to protection within the full scope of the appended claims.

What is claimed is:

1. A processing chamber comprising:
an outer vessel;
an inner member within the outer vessel;
a mixing passage formed between an inner member and the outer vessel, the inner member and outer vessel stationary in relation to each other;
an inlet for material, the inlet coupled to the passage; and
an outlet for material, the outlet coupled to the passage,
the passage sufficiently narrow such that the material supplied at high pressure travels from the inlet to the outlet with a high degree of shear flow substantially without the formation of Taylor vortices in the mixing passage.

2. The processing chamber of claim 1, wherein walls of the passage are sufficiently free of irregularities such that when the material travels from the inlet to the outlet it is mixed without the formation of Gortler vortices.

3. The processing chamber of claim 1, wherein the outer vessel and inner member are spherically shaped.

4. The processing chamber of claim 1, wherein the outer vessel and inner member are cylindrically shaped.

5. A method for mixing fluid materials, comprising:
supplying the fluid materials to a mixing chamber at a high input pressure; and
passing the materials between first and second opposing surfaces of the mixing chamber, the first and second surfaces unmovable in relation to each other, the distance between the first and second surface insufficient to support the formation of Taylor vortices but sufficient to create high shear flow at the high input pressure as the materials pass between the first and second surfaces.

6. The method of claim 5, wherein the first and second opposing surfaces are cylindrical.

7. The method of claim 5, wherein the first and second opposing surfaces are spherical.

8. The method of claim 5, wherein the first and second opposing surfaces are planar.

9. A method of producing biodiesel fuel, comprising:
receiving a first input stream comprising oil or grease;
receiving a second input stream comprising alcohol;
receiving a third input stream comprising a catalyst; and
mixing the first, second, and third input streams by passing the streams though a mixing chamber consisting entirely of fixed surfaces, the mixing chamber configured to prevent the formation of vortices.

10. The method of claim 9, further comprising removing the catalyst or unwanted byproducts thereof after mixing.

11. The method of claim 9, further comprising the steps of premixing the first, second and third input streams prior to passage through the mixing chamber.

12. The method of claim 9, further comprising separating the biodiesel fuel from glycerin produced as a result of the mixing.

13. The method of claim 9, further comprising heating the constituent materials of one or more of the first, second or third input streams.
